(19) United States
(12) Patent Application Publication
(10) Pub. No.: US 2025/0269826 A1
(43) Pub. Date: Aug. 28, 2025

(54) CLEANING STATION FOR CLEANING A CARGO SPACE OF A TRANSPORT DEVICE

(71) Applicant: KATMA ENGINEERING GMBH, Rietberg (DE)

(72) Inventors: Felix KATHOEFER, Rietberg (DE); Patrick KATHOEFER, Duesseldorf (DE)

(21) Appl. No.: 19/073,691

(22) Filed: Mar. 7, 2025

Related U.S. Application Data
(63) Continuation of application No. PCT/EP2023/074421, filed on Sep. 6, 2023.

(30) Foreign Application Priority Data
Sep. 7, 2022 (DE) 102022122694.8

(51) Int. Cl. B60S 3/00; B08B 3/04; B08B 13/00

(52) U.S. Cl. CPC B60S 3/008; B08B 3/04; B08B 13/00

(57) ABSTRACT

A cleaning station for cleaning a cargo space of a transport device, the cleaning station including an inherently stable support frame configured to support a pedestal above a ground; a cleaning robot; a garage, configured to receive the cleaning robot; a fluid supply, configured to supply the cleaning robot with a cleaning fluid; and a control unit, wherein the support frame includes at least one stand element configured to support the support frame on a support plane on the ground, wherein the garage includes an interior space enclosed by a floor, a roof, and side walls, wherein at least one of the side walls of the garage is at least partially configured as an openable space divider element, wherein the cleaning robot is alternatively movable out of the garage or into the garage in an open position of the space divider element.

### RELATED APPLICATIONS

This application is a continuation of international patent application PCT/EP2023/074421, filed on Sep. 6, 2023, claiming priority from German patent application DE 10 2022 122 694.8, filed on Sep. 7, 2022, both of which are incorporated in their entirety by this reference.

### FIELD OF THE INVENTION

The instant application relates to a cleaning application for cleaning a cargo space of a transport device.

### BACKGROUND OF THE INVENTION

It is known in the art to use a cleaning robot for cleaning a loading space of a transport device. Reference is made to the publication document DE 10 2019 004 959 A1. The cleaning robot is moved into the loading space of the transport device in order to perform the cleaning and thereafter the cleaning robot is moveable within the loading space by an internal propulsion of the cleaning robot. The surfaces of the walls of the transport device are typically cleaned by dispensing a cleaning fluid that is sprayed through cleaning nozzles. Thus, all surfaces of the walls of the transport device are sprayed with the cleaning fluid during a movement of the cleaning robot along a longitudinal axis of the loading space so that the entire loading space is cleaned. The cleaning robot is removed from the loading space after completion of the cleaning.

According to this document, the cleaning robot is placed in the cargo space by a forklift that lifts the cleaning robot to the elevation of the cargo space and subsequently places it into the cargo space. Thereafter, the cleaning robot is capable of cleaning the cargo space as described supra. The process is inverted in order to retrieve the cleaning robot from the cargo space. This type of handling is complicated and has to be individually accompanied by a person.

A cleaning robot comparable to the robot according to DE 10 2019 004 959 A1 can be derived from US 2019/0023234 A1.

### BRIEF SUMMARY OF THE INVENTION

Thus, it is an object of the invention to provide a cleaning station that is mostly operable in an automated manner, advantageously, operable in a completely automated manner.

The object is achieved according to the invention by a cleaning station for cleaning a cargo space of a transport device, the cleaning station including an inherently stable support frame configured to support a pedestal above a ground; a cleaning robot; a garage, configured to receive the cleaning robot; a fluid supply, configured to supply the cleaning robot with a cleaning fluid; and a control unit, wherein the support frame includes at least one stand element configured to support the support frame on a support plane on the ground, wherein the garage includes an interior space enclosed by a floor, a roof (15), and side walls, wherein at least one of the side walls of the garage is at least partially configured as an openable space divider element, wherein the cleaning robot is alternatively movable out of the garage or into the garage in an open position of the space divider element, and wherein the cleaning robot is storable in the garage, protected against unauthorized access when the space divider element is in the closed position, wherein the fluid supply includes a fluid tank, a pump and a fluid conduit operatively connected with the fluid tank and the cleaning robot indirectly or directly, so that cleaning fluid stored in the fluid tank is pumpable indirectly or directly by the pump through the fluid conduit to the cleaning robot, wherein the control unit is configured to control operations of the cleaning station according to at least one cleaning program so that the cleaning robot automatically performs a cleaning process to clean the cargo space.

Advantageous embodiments can be derived from the dependent claims.

The transport device can be in particular a truck or a semi-trailer. The cargo space is typically formed by walls, in particular, a cargo space floor, a cargo space ceiling, lateral walls and a face wall, wherein the cargo space floor, the cargo space ceiling, and the walls jointly define a cuboid. One of the walls typically opposite from the face wall is configured openable, e.g. by pivoting doors, so that the cargo typically configured as solid objects is moveable into the cargo space and removable from the cargo space. The openable wall is typically closed in order to perform the transportation, and the respective cargo is secured in the cargo space.

The cleaning station includes a cleaning robot that is provided and configured to clean the cargo space self-acting or automatically. The cleaning robot is typically provided with a chassis so that the cleaning robot is movable within the cargo space for this purpose. The chassis can be formed e.g. by a track chassis that includes two parallel drive tracks that are advantageously drivable independently from each other. Additionally, the cleaning robot is typically configured to dispense a cleaning fluid, wherein surfaces of walls of the transport device are cleaned by the cleaning fluid in order to perform the cleaning. The cleaning fluid can be dispensed in particular by a plurality of cleaning nozzles that are oriented towards the walls so that the cleaning fluid can be sprayed onto the walls. At least in order to perform self-acting cleaning of the cargo space, the cleaning robot is controlled by a control unit. “Self-acting” or “automatically” thus means according to the instant invention that cleaning the cargo space can also be performed without user interaction. A user may also manually select a cleaning program according to which the cargo space is to be cleaned. This cleaning program defines operating parameters for the cleaning robot to perform at least one cleaning process, e.g., a temperature of the cleaning fluid, a fluid amount to be dispensed and/or a concentration of a cleaning agent in the cleaning fluid. The cleaning robot can subsequently perform the cleaning of the cargo space without user interaction and thus operates self-acting or automatically according to the instant application. At least one operating parameter can also be adjusted at least once while the cleaning process is being performed.

Cleaning the loading space can include one cleaning run or several cleaning runs. A cleaning run can include, in particular, a movement of the cleaning robot initially forward in a main direction of the cleaning robot along an entire length of the loading space and then back opposite to the main direction along the entire length of the loading space. Depending on a contamination of the loading space, plural cleaning processes can be required in order to achieve a desired cleanliness of the loading space.

The cleaning station includes an inherently stable support frame that provides a pedestal above a ground wherein the support frame is supported on the pedestal. The support frame can be formed by a steel structure. The support frame includes at least one stand element that is configured to place the support frame on a support plane on the ground. The stand element can be formed e.g. by a stand base. The pedestal or a driving plane on which the cleaning robot is drivable is arranged vertically above the support plane. This creates an intermediary space between the pedestal and the ground.

Inherently stable according to the invention means that the support frame is capable of standing up by itself. The at least one stand element can be configured as a vertical support. The support frame may include a plurality of stand elements wherein a horizontal plate contacts upper ends of the stand elements wherein the horizontal plate is supported by the stand elements at a vertical distance from the support plane. In this embodiment, the plate forms the pedestal.

The cleaning station additionally includes the cleaning robot described supra that is configured to clean the cargo space of the respective transport device.

The cleaning station additionally includes a garage, from which the cleaning robot is retrievable. Thus, the cleaning robot is positioned in the garage in a parking position. The garage includes a floor, a ceiling, and side walls jointly defining an interior space of the garage. At least one side wall of the garage is configured as an openable divider space element that is adjustable between an open position and a closed position. When placed in the open position, the interior of the garage is accessible so that the cleaning robot is alternatively movable out of the garage and into the garage. When the space divider element is in the closed position, the cleaning robot is protected against unauthorized access when parked in the garage. The openable space divider element can be configured in particular as a rolling door or similar.

The cleaning station additionally includes a fluid supply configured to supply the cleaning robot with a cleaning fluid. The fluid supply includes at least one fluid tank, configured to store the cleaning fluid. The fluid supply includes at least one pump, configured to pump the cleaning fluid to the cleaning robot. Thus, the pump is operatively connected with the fluid tank indirectly or directly and cooperates with a fluid conduit configured to pump the cleaning fluid. The fluid conduit is connected with the cleaning robot at an end oriented away from the fluid tank. The fluid supply advantageously includes a plurality of fluid tanks as will be described infra. As soon as dispensing of cleaning fluid through the cleaning robot is to commence in the cargo space to be cleaned, the cleaning fluid included in the fluid tank can be pumped through the fluid conduit to the cleaning robot so that the cleaning fluid is applied to surfaces of walls of the cargo space by cleaning nozzles. The fluid supply is advantageously arranged below the pedestal, advantageously in an intermediary space between the pedestal and the ground on which the support frame is supported. The fluid supply can be enclosed by a housing in order to protect it against external influences.

Eventually, the cleaning station includes at least one control unit configured and provided to control operations of the cleaning station according to at least one cleaning program. This relates in particular to operations of the cleaning robot as such, so that the cleaning robot can automatically perform at least one cleaning process to clean the cargo space advantageously perform an entire cleaning run automatically. The control unit is configured in particular to issue control commands that cause a movement of the cleaning robot, dispensing of the cleaning fluid and similar. Thus, the control unit can be arranged stationary directly or indirectly at the support frame or at ta frame of the cleaning robot. The cleaning unit can include e.g., a computing unit, a storage unit, and an input device.

The cleaning station according to the invention has many advantages. It enables autonomous operations, in particular, so that cleaning the cargo space of a transport device is enabled without an operator. This is of particular interest in since the cleaning station is operable independently from business hours, this means operable 24 hours per day. In order to use the cleaning station, it is only required to move transport devices to be cleaned to the cleaning station, this means position the cargo space relative to the pedestal so that the cleaning robot can drive over from the pedestal into the cargo space. The cleaning can be performed according to a previously set cleaning program so that a user of the cleaning station can select the cleaning program at will. The control unit advantageously cooperates with an input device and with a display device so that a user can perform entries and information is displayed to the user.

The cleaning robot is arranged in the garage in its parking position during times when the cleaning station is not operated so that the cleaning robot is protected against unauthorized access. Thus, an effort to monitor the cleaning station is minimal. In order to operate the cleaning station, it can be connected to an external water supply in order to supply fresh water and to an external energy supply in order to supply the cleaning station with electrical energy. Refilling the cleaning fluid can be required periodically when the cleaning fluid is used and consumed to perform the cleanings. Thus, the fluid supply of the cleaning fluid may advantageously include a fluid tank configured to store the cleaning agent.

It is particularly advantageous for operating the cleaning station to make it operable in cooperation with a booking system that is operable by a user of the cleaning station. Thus, it is conceivable that a user books and bills cleaning a particular transport device during a predetermined time window through a user account wherein the cleaning station is made available automatically and optionally started by manual activation.

A floor of the garage is formed by a portion of the pedestal in a particularly advantageous embodiment of the cleaning station wherein the pedestal advantageously includes an outer portion outside of the garage. Put differently, the garage includes a portion of an entire surface of the pedestal in this embodiment wherein a portion of the pedestal forms the floor of the garage and the side walls of the garage extend vertically from the surface of the pedestal. This embodiment has the advantage that the cleaning robot does not have to cover any elevation difference when moving out of the garage but can transition directly into the outer portion of the pedestal. The outer portion of the pedestal has the advantage in turn that doors of the respective transport device can be stopped laterally from the pedestal and can also be cleaned by the cleaning robot while the cleaning robot sits on the outer portion of the pedestal and thus outside of the garage. Using this process, the doors of the transport device are opened at an angle of 80 degrees to 100 degrees relative to a closing position and the transport device is arranged relative to the cleaning station so that the doors are arranged laterally from the pedestal. Thus, cleaning the doors is performed in a position of the cleaning robot where the cleaning robot is not yet in the cargo space of the transport device or not in the cargo space of the transport device anymore.

An embodiment of the cleaning station is particularly advantageous where the cleaning station includes at least one sensor, advantageously a plurality of sensors. At least one sensor can be advantageously formed by a camera. At least one sensor can be formed by a lidar. The at least one sensor is connected with a data processing device in a data transmitting manner, wherein information captured by the sensor is conductible to the data processing device. Thus, it is conceivable that the cleaning station includes a transceiver configured to transmit and receive data. The at least one sensor can be arranged e.g. at a front edge of the roof of the garage or within the garage at a ceiling of the garage or at a rear side wall of the garage and oriented towards an area in front of the cleaning station so that the sensor is suitable to capture the transport device and/or the cargo space of the transport device when the transport device is in a parking position proximal to the cleaning station. It is also conceivable to arrange at least one sensor below the pedestal, wherein the sensor is particularly suited to capture a vehicle license plate of the transport device. Locating the at least one sensor at another location of the cleaning station is also conceivable.

The data processing device configured to process the information can be configured as part of the control unit that includes that data processing device. Thus, the data processing device can be locally configured as part of the cleaning station. The data processing device can also be configured as an external data processing device. This can also include that the data processing device is not indirectly or directly arranged at the support frame of the cleaning station as a physical part, but connectable via internet. Accordingly, the data processing device can be arranged in the cloud wherein information of the at least one sensor is transmitted to the data processing device through the internet, processed in the data processing device and eventually processed information is transmitted through the internet to the local control unit. The local control unit can generate control commands and control the cleaning station as a function of the received information.

The data processing device is advantageously arranged and configured to process the information captured by the at least one sensor and to adjust at least one operating parameter of the cleaning robot as a function of the processed information. This adjustment can be performed directly, however, it is performed indirectly by using the control unit. It is conceivable in particular that the at least one sensor detects a contamination of the cargo space and the respective information is processed by the data processing device. Thereafter, the control unit can adjust at least one operating parameter of the cleaning robot after detecting the contamination condition so that the contamination is considered individually when performing the at least one cleaning process. It is conceivable for example when the cleaning fluid is sprayed with a predetermined, e.g. particularly high pressure or a temperature of the cleaning fluid is increased above an otherwise typical level. A plurality of other operating parameters relating to operations of the cleaning robot are also conceivable. Another operating parameter of the cleaning robot relates to cleaning operations of the cleaning robot in order to perform at least one cleaning process for cleaning the cargo space.

When at least one sensor is formed by a lidar, a cargo space to be cleaned can be advantageously measured by the sensor. This way, in particular a length, width, and height of the cargo space can be determined. This information can be subsequently used for controlling the cleaning robot.

Additionally, an embodiment of the cleaning station can be particularly advantageous where at least one identification feature of the transport device is detectable using the at least one sensor. The identification feature can be e.g. a vehicle license plate of the transport device and/or an RFID chip and/or a QR code and/or a bar code. The sensor can be configured e.g. by an optical sensor, e.g., a camera. The information captured by the sensor is transmittable to the data processing device and processable by the data processing device so that the transport device whose cargo space is to be cleaned becomes identifiable. Thus, it is conceivable that the data processing device accesses a database where data relating to the transport device has been stored that facilitates an association of the respective identification feature with the transport device. The identification of the respective transport device has a particular advantage in that the cleaning can be performed individually for the identified transport device. It is conceivable for example that at least one operating parameter of the cleaning robot is adjusted by the data processing device indirectly through the control unit or directly which facilitates cleaning the cargo space. It can be stored in the data processing device regarding the identified transport device which products were transported last and which cleaning requirement results therefrom. The configuration of the cleaning robot can be adjusted for the cleaning accordingly.

Additionally, an embodiment of a cleaning station is particularly advantageous where the at least one sensor is configured to capture an elevation level of the cargo space floor of the cargo space. This has the advantage that an elevation difference between the elevation level of the cargo space floor and an elevation level of a driving plane of the pedestal can be determined. The sensor can be formed e.g. by an optical sensor, e.g., a camera. It is particularly advantageous for driving the cleaning robot into the cargo space when the recited elevation difference is a few millimeters at most advantageously zero. Thus, knowing the elevation level of the cargo space floor, it is possible to give signals to a driver of the transport device e.g. using the signaling system wherein the signals indicate an amount of the elevation difference to the driver. A qualitative statement is feasible, e.g. the cargo space floor is too high or too low. Thus, the driver is enabled to adjust the transport device so that the elevation difference is reduced or advantageously disappears completely. In a transport device formed by a semi-trailer, adjustments of the elevation level of the cargo space floor can be typically performed pneumatically or hydraulically from a cab of an associated tractor.

In another advantageous embodiment of the cleaning station according to the invention includes a capture device that is arranged at an elevation level below a driving plane of the pedestal. The capture device includes at least one capture container, in particular, a plurality of capture containers, configured to capture the cleaning fluid. Arranging the capture device below the driving plane of the pedestal where the cleaning robot is able to drive, facilitates capturing the cleaning fluid, which was previously dispensed by the cleaning robot. In particular, the cleaning robot can be flushed out of the cargo space, wherein the cleaning fluid exits the cargo space at a rear wall of the cargo space floor. Since the cargo space floor is advantageously arranged at the same elevation level as the driving plane of the pedestal, the capture device arranged below the driving plane is configured to capture the cleaning fluid. The same applies for the cleaning fluid that is dispensed outside of the cargo space, e.g., in an outer area of the pedestal. As described supra, this can be performed e.g., for cleaning doors of the transport device. Capturing the cleaning fluid has the advantage that captured cleaning fluid can be recirculated and reused for another cleaning process.

In order to reuse captured cleaning fluid in a particularly effective manner, it is advantageous when the cleaning station includes a processing device configured to process the captured cleaning fluid. Thus, the processing device can include at least one filter, advantageously a plurality of filters. Thus the cleaning fluid can be processed so that at least a portion of the cleaning fluid is reusable for another cleaning process. Thus, processed cleaning fluid can be mixed with fresh cleaning fluid that is formed by a chemical cleaning agent so that an overall consumption of the cleaning agent is reduced. Accordingly, the cleaning station is operable in a particularly efficient and ecological manner in this embodiment.

A fluid supply is particularly advantageous that includes at least two, advantageously three, fluid tanks. One of the fluid tanks can be formed e.g. by a water tank that is configured to store fresh water. Another fluid tank can be configured as a cleaning agent tank configured to store the cleaning agent. The cleaning fluid that is dispensed by the cleaning robot is typically formed by a mix of fresh water and cleaning agent. Accordingly, it can be advantageous when the fluid supply includes another fluid tank that includes the cleaning fluid. A switching of the fluid tanks can be advantageous where the fresh water and the cleaning agent are fed into the additional fluid tank where the cleaning fluid is mixed. Additionally, captured and processed cleaning fluid can be fed into the additional fluid tank. The cleaning fluid thus formed can then be pumped by the pump through the fluid conduit to the cleaning robot. In the embodiment described infra, the fluid tank including the freshwater is designated as the first fluid tank, the fluid tank that includes the cleaning fluid is designated as the second fluid tank, and the fluid tank that includes the cleaning agent is designated as the third fluid tank.

According to an advantageous embodiment, the cleaning station includes at least one door support, configured to stop the door of the transport device in a defined open position when the cargo space is to be cleaned. Advantageously the cleaning station includes two door supports so that wo doors of the transport device are fixable in position. Advantageously, at least one door support is configured to stop a door of the respective transport device at an opening angle between 80 degrees and 110 degrees, advantageously between 85 degrees and 100 degrees. This is particularly advantageous for cleaning the doors of the transport device as described supra. Accordingly, it is also advantageous when a respective door support is associated with one side of a perimeter of the pedestal so that the doors of the transport device are laterally fixable at the pedestal and thus cleanable by the cleaning robot in a particularly simple manner. The door support can include a suction cup so that the door is fixable by the suction cup supplied with a vacuum. Advantageously, the door support is configured to cooperate with an outer surface of the door, so that an inner surface of the door oriented towards the cargo space and oriented towards the cargo space in a closed position of the door is accessible in its entirety and therefore loadable with the cleaning fluid in its entirety.

In an advantageous embodiment, the cleaning station includes a winch, including a pull cable, windable onto a storage roller. An end of the pull cable oriented away from the storage roller is connectible or connected to the cleaning robot so that the pull cable is rollable onto the storage roller by operating the cable winch so that the cleaning robot is pullable towards the storage roller. The winch is advantageously arranged at a rear side wall of the garage so that the cleaning robot is pullable into an interior of the garage using the cable winch. This cable winch can be required when the cleaning robot breaks down and cannot move anymore under its own power. A breakdown of this type can be caused by damage to a chassis of the cleaning robot or a failure of the electrical power supply. Even in this case it is necessary to pull the cleaning robot from the cargos space of the transport device to be cleaned so that the transport device can depart from the cleaning station. Thus, the cable winch is used to extract the cleaning robot from the cargo space in an emergency. The cable winch can include a crank for manual operation as well as an electrical drive wherein the cable winch can cooperate with a battery in case the external power supply of the cable winch fails wherein the battery supplies energy to the electric drive in order to assure reliable operations.

In an advantageous embodiment, the cleaning station includes a cleaning deice arranged in the interior of the garage and configured to clean the cleaning robot. The cleaning device can be arranged at the roof of the garage so that cleaning fluid is sprayable from above onto the cleaning robot arranged in its parking position through the at least one cleaning nozzle of the cleaning device. The cleaning device is particularly advantageous for a completely autonomous operation of the cleaning station since a manual cleaning of the cleaning robot which should be performed in periodic intervals, advantageously after each cleaning of a cargo space. The cleaning device can be connected with the at least one fluid tank of the fluid supply through at least one fluid conduit so that the same cleaning fluid is feedable to the cleaning device by a pump wherein that cleaning fluid is also dispensed by the cleaning robot into the cargo space.

Advantageously, the cleaning station includes a crash bumper that prevents an impact at the support frame of the cleaning station of a transport device driving into the parking position. Advantageously, the crash bumper is arranged at a front end of the support frame, so that a transport device that is being positioned relative to the cleaning station impacts the crash device first and thus prevents damages to the remainder of the cleaning station. The crash bumper can include, in particular, a ram that is anchored in a ground where the cleaning station is positioned, e.g., anchored by a foundation. Alternatively, it is also conceivable that the crash bumper includes a base plate that is placed on the ground at a front side of the support frame and oriented in a direction away from the support frame so that the transport device that approaches the cleaning station drives onto the base plate. Thus, the ram is arranged at an end of the base plate that is oriented towards the support frame in this embodiment and fixed at the base plate. The crash bumper is fixed at the ground in this embodiment by the weight of the transport device, wherein the base plate establishes friction locking with the ground through the weight of the transport device that is reacted into the ground through the base plate. This embodiment has the advantage that no construction work is required in the ground at the installation location of the cleaning station. Thus, the cleaning station as such remains mobile and can be removed from a respective installation location with little complexity transported and installed again at another installation location.

### BRIEF DESCRIPTION OF THE DRAWINGS

The invention is subsequently described based on an advantageous embodiment with reference to drawing figures, wherein:

FIG. 1 illustrates a vertical longitudinal sectional view of a set including a cleaning station and a transport device;

FIG. 2 illustrates a horizontal sectional view of the set according to FIG. 1;

FIG. 3 illustrates a perspective view of a cleaning station;

FIG. 4 illustrates a front view of the cleaning station according to FIG. 3.

FIG. 5 illustrates a vertical longitudinal sectional view of the cleaning station according to FIG. 3;

FIG. 6 illustrates a perspective view of a cleaning robot;

FIG. 7 illustrates a front view of the cleaning robot according to FIG. 6; and

FIG. 8 illustrates a side view of the cleaning robot according to FIG. 6.

### DETAILED DESCRIPTION

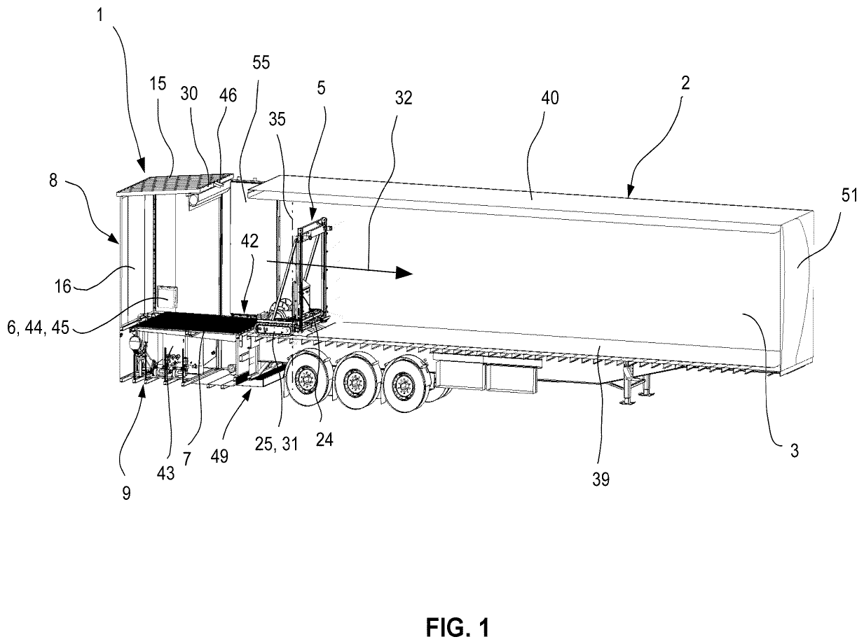

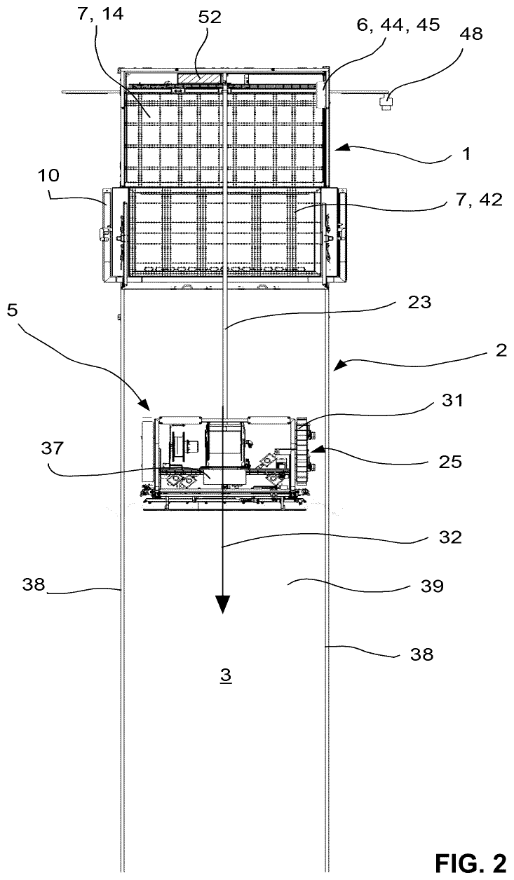

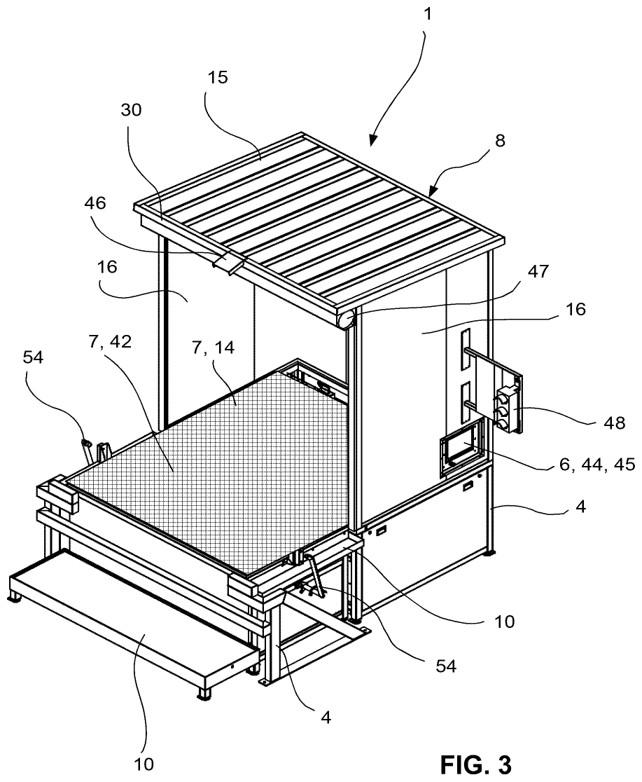

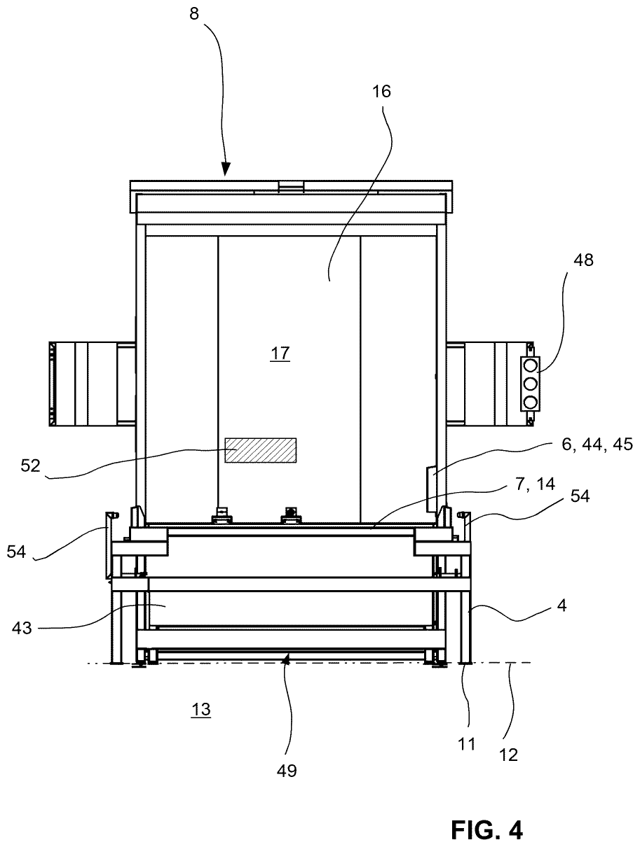

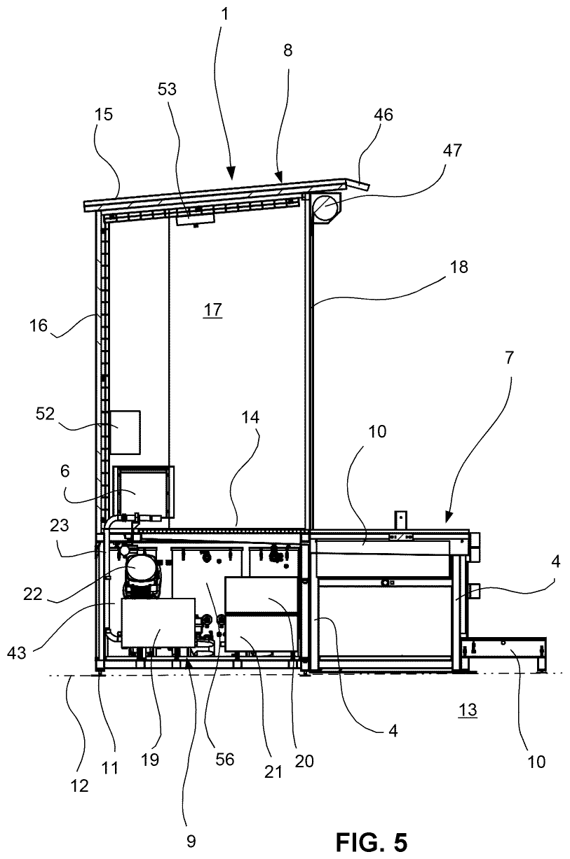

An embodiment illustrated in FIGS. 1-8 includes a cleaning station 1 including a cleaning robot 5 for cleaning a cargo space 3 of a transport device 2. The transport device 2 is formed in this embodiment by a trailer with a cargo space 3 that is to be cleaned. In order to perform the cleaning, the transport device 2 is positioned relative to the cleaning station 1 so that the cleaning robot 5 can enter the cargo space 3 of the transport device 2. The cleaning robot 5 is provided and configured to perform the cleaning of the cargo space 3 self-acting or automatically, this means, in particular, without interaction from a user of the cleaning station 1.

The cleaning station 1 that is illustrated in FIGS. 1-5 includes a support frame 4 that forms a pedestal 7 at an end oriented away from a ground 13. The pedestal 7 is thus offset from the ground 13, wherein the pedestal 7 forms a flat driving plane that is oriented essentially parallel to a surface of the ground 13. The arrangement of the pedestal 7 as described supra enables the cleaning robot 5 that is supported on the pedestal 7 to enter the cargo space 3 of the transport device 2 from the pedestal 7 without having to cover an elevation difference, wherein the pedestal 7 and a cargo space floor of the transport device 2 are at least on a similar, advantageously on the same elevation level.

The cleaning station 1 furthermore includes a garage 8 in which the cleaning robot 5 is storable in a parking position when not in use. The garage 8 includes a plurality of side walls 16, a floor 14, a ceiling 15, wherein these elements jointly enclose an interior space 17 of the garage 8. The interior space 17 is defined by a side wall 16 towards a front side of the garage 8, wherein the side wall 16 is formed by an openable space divider 18. The space divider 18 is optionally moveable between an open position and a closed position. In the illustrated embodiment, the space divider element 18 is formed by a rolling door which is rolled up and stored in a storage box 47 when the space divider element 18 is provided in its open position. When the space divider 18 is in its closed position, it secures the interior of the garage 8 against unauthorized access. The floor 14 of the garage 8 is formed by the pedestal 7 in the illustrated embodiment so that the floor 14 of the garage 8 extends from an outer area 42 of the pedestal 7 without any elevation difference. Thus, the cleaning robot 5 can move out of the garage 8 without having to drive up or down a step or a ramp or similar.

The support frame 4 of the cleaning station 1 includes a plurality of stand elements 11 which support the cleaning station on the ground 13 in a support plane 12. As stated supra, the pedestal 7 is oriented parallel to the support plane 12. Since there is a distance between the support plane 12 and the pedestal 7, an intermediary space 43 is provided between the pedestal 7 and the support plane 12 wherein a fluid supply 9 is arranged in the intermediary space 43. The fluid supply includes a plurality of fluid tanks 19, 20, 21, and a pump 22. A first fluid tank 19 is formed by a water tank and is configured to store fresh water in the illustrated embodiment. The first fluid tank 19 can be configured with a supply connection in the illustrated embodiment, wherein the fluid tank 19 is connectible to an external supply conduit so that it is fillable with fresh water, e.g. from a municipal water supply. The fluid supply 19 also includes a second fluid tank 20 which is formed by a cleaning fluid tank. Thus, the second fluid tank 20 is configured to store a cleaning fluid that is provided for dispensing into the cargo space 3 by the cleaning robot 5. The third fluid tank 21 is configured as a cleaning fluid tank to store the cleaning fluid which is typically formed by a particular chemical mixture. The cleaning fluid that is stored in the second fluid tank 20 is typically formed by a mixture which includes captured cleaning fluid which was previously applied by the cleaning robot 5 and then captured again by the capture device 49 and fresh cleaning fluid. The cleaning robot 5 is supplied with the cleaning fluid from the second fluid tank 20 which is flow-connected with the cleaning robot 5 by a fluid conduit 23. The pump 22 cooperates with the fluid conduit 23 so that it is configured to pump the cleaning fluid stored in the fluid tank 20 through the fluid conduit 23 into the cleaning robot 5 that eventually sprays the cleaning fluid.

The cleaning station 1 further includes a capture device 49 which includes plural capture containers 10 in the illustrated embodiment wherein the capture containers are configured to capture and re-circulate cleaning fluid dispensed during the cleaning of the transport device 2. Individual capture containers 10 are respectively arranged at a level below an upper driving plane of the pedestal 7 for this purpose. Additionally, the driving plane of the pedestal 7 where the cleaning robot 5 can drive is formed by a grate so that dispensed cleaning fluid 10 can drain downward through the grate and can be supplied to the capture device 49 in this way.

The cleaning station 1 can additionally include a processing device 56 wherein captured cleaning fluid is feedable to the capture device, in particular, by a pump. The processing device 56 facilitates processing the cleaning fluid so that the cleaning fluid is at least partially suitable for performing another cleaning process. Processing the cleaning fluid can be performed, in particular, by filtering solids out of the cleaning fluid using one or plural filters. The portion of the processed cleaning fluid that is suitable for further use is then fed into the second fluid tank 20. As stated supra, additional cleaning fluids can be fed into the fluid tank 20.

The cleaning station 1 additionally includes an energy supply configured to supply the cleaning station 1 and, in particular, the cleaning robot 5 with electrical energy. This supply can be performed indirectly or directly wherein in particular a certain amount of electrical energy can be stored in an intermediary battery. The energy supply includes a supply connection that is connectible with an external supply conduit.

Additionally, the cleaning station 1 includes a control unit 6 that is fixed at a sidewall of the garage 8. The control unit 6 is configured and provided to control the cleaning station 1 and, in particular, the cleaning robot 5. For this purpose, the control unit 6 is connected in a data transferring manner with the cleaning robot 5 by at least one data connection. This data connection can be hardwired or provided wirelessly. In the illustrated embodiment, the cleaning robot 5 is connected to the cleaning station 1 with an additional supply conduit in addition to the fluid conduit 23, wherein the cleaning robot 5 is suppliable with electric energy from the energy supply and also with data from the control unit 6.

In the illustrated embodiment, the control unit 6 includes a data processing device which is configured to electronically process supplied information. This can be in particular information that is captured by various sensors which will be described infra. Processing this information is used in the illustrated embodiment to control the cleaning robot 5 by the control unit 6 as required and to influence a cleaning process of the storage space 3 of the transport device 2 in this manner.

The control unit 6 includes an input device 44 and a display device 45 in the illustrated embodiment which are combined in a touch screen display. This way, the operator of the cleaning station 1 is enabled to perform inputs relating to at least one cleaning process or the entire cleaning job. It is conceivable, for example, to display options for various cleaning programs to the user through the display 35 wherein the user can select between the cleaning programs. Depending on which of the cleaning programs is selected, at least one cleaning process of the storage space 3 is controlled for the cleaning robot 5 by the control unit 6. Different cleaning programs can cause different operating parameters of the cleaning robot 5 so that the cleaning can be performed in different ways automatically as a function of the selected cleaning program.

The cleaning station 1 additionally includes a signalling device 48 which can be laterally connected to a side wall 16 of the garage 8 like a traffic light. The signalling device 48 can be used for different purposes. In particular, the signalling device 48 can optically indicate to the driver of a respective transport device 2 that a parking position relative to the cleaning station 1 has been reached. It is understood that the transport device 2 has to be positioned relative to the cleaning station 1 so that the cleaning robot 5 can drive from the pedestal 7 into the cargo space 3 of the transport device 2. It is particularly advantageous when only a small or no elevation difference is provided between an elevation level of a cargo space floor 39 of the cargo space 3 to be cleaned and an elevation level of the driving plane of the pedestal 7.

In order to secure the support frame 4 against unintentional impact of a transport device 2 driving into its parking position, it can furthermore be advantageous when the cleaning station 1 includes a crash bumper. The crash bumper is arranged relative to the transport frame 4 so that the transport device 4 initially contacts the crash bumper when driving towards the cleaning station 1 before impacting the support frame 4. The crash bumper can be anchored in the ground e.g. by a foundation. In order to be able to flexibly deploy the cleaning station without ground construction, it is particularly advantageous when the crash bumper is stabilized by the weight of the transport device 2. For this purpose, the crash bumper can include a ram, which is connected at one end at an elongated base plate. The elongated base plate can be oriented relative to the transport frame 4 so that the transport device 2 drives onto the base plate when moving into a parking position at the cleaning station 1 and thus fixes the crash bumper relative to the ground 13 by friction locking.

Furthermore, the signalling device 48 in the illustrated embodiment is configured to optically display an elevation difference between the elevation level of the cargo space floor of the transport device 2 and the elevation level of the driving plane of the pedestal 7 to the driver of the transport device 2. For the reasons recited supra, this elevation difference shall be minimal, advantageously zero so that the cleaning robot does not have to cover any elevation difference when moving from the pedestal 7 into the cargo space 3. An adaptation of the elevation level of the cargo space floor 39 to the elevation level of the pedestal 7 can be performed in particular by the transport device 7, so that the driver can perform the adaptation in view of the signal displayed by the signalling device 48.

Additionally, the cleaning station 1 includes two door supports 54, wherein one respective door support is arranged at one respective side of the pedestal 7. The door supports 54 are used to stop the doors 55 of the transport device 2 in their open position. This is evident, in particular, from FIG. 1. Due to the extension of the pedestal 7 in its outer area 42, it is possible to position doors 55 of the transport device 2 in their open position respectively, lateral from the pedestal 7 and to make the cargo space accessible for cleaning by the cleaning robot 5 in this way. Thus, the cleaning robot 5 is positioned outside the garage 8 in the outer portion 42 of the pedestal 7 and activated so that the doors 55 arranged laterally from the pedestal 7 are loaded with the cleaning fluid and thus cleaned. The door supports 54 are used to stop the doors 55 during the cleaning so that the cleaning can be performed reliably. In particular, the door supports 54 can respectively include a suction cup that is configured to grip a respective door 55 at an outside through vacuum. The door supports 54 can be arranged at the support frame 4 in a force transferring manner and can react forces into the door frame 4, wherein the forces are generated by stopping the doors 55. Advantageously, the door supports 54 are arranged so that they are suitable for stopping the doors 55 at an opening angle of approximately 90 degrees.

The cleaning station 1 additionally includes a sensor 46 that is formed by a camera in the illustrated embodiment. The sensor 46 is arranged at a front edge 30 of the roof 15 of the garage 8. The sensor 46 is oriented forward in a direction towards a front end of the cleaning station 1 or towards the transport device 2 so that the sensor is configured to capture optical information relating to the transport device 2 and the cargo space 3. The sensor 46 is connected with the data processing device so that data is transferable wherein the data processing device is configured as part of the control device 6 according to the embodiment described supra. This way, it is possible to transfer information captured by the sensor 46 to the data processing device and process the data in the data processing device.

The sensor 46 is configured in particular to capture at least one identifying feature of the transport device 2. In the illustrated embodiment the sensor 46 is configured to optically capture a license plate of the transport device 2, wherein the license plate functions as an identifying feature of the transport device 2. Information captured this way is compared to data already provided in the data processing device relating to the transport device 2 and stored in a database. This database is not configured in the illustrated embodiment locally as part of the data processing device, but is arranged in a cloud, wherein an exchange of data between the database and the data processing device is performed through the internet. Data is stored in the database facilitating an association of the optically captured license plate through the sensor 46 with the transport device 2 so that the transport device 2 is clearly identified whose cargo space 3 is to be cleaned.

The identification of the transport device 2 thus performed is furthermore used to generate a cleaning certificate after the cleaning of the cargo space 3 is completed, wherein the cleaning certificate documents the completed cleaning. This cleaning certificate is then associated with the identified transport device 2 and documented in a database. This can be e.g. the same database that includes the association of the license plate with the transport device 2. This type of data processing provides in particular the option to access the cleaning certificate any time by accessing a user account of a respective customer regarding the transport device 2 that is part of a fleet of that customer and to report the successful performance of the cleaning of the cargo space 2 as may be required by a controlling authority.

Additionally, the identification of the respective transport device 2 can be useful in order to control the cleaning robot 5 for at least one cleaning process that is to be performed. It is conceivable that the type of the transport device 2 is stored in the database with respect to the transport device 2 and which type of contamination of the cargo space 3 is to be expected. The transport device 2 may have been used to transport food products which constitutes certain requirements for cleaning the cargo space 3. Thus, the identification of the transport device 2 facilitates automatically setting at least one operating parameter of the cleaning robot 5 for at least one cleaning process so that the cleaning process can be adapted to the expected contamination and a pre-determined cleaning goal. It is conceivable that the cleaning fluid dispensed by the cleaning robot 5 is heated to a pre-determined temperature for cleaning the cargo space 3 where food products were transported previously in order to efficiently remove the contamination of the cargo space 3. It is also conceivable that the cleaning is performed in view of the next cargo that is to be transported.

Furthermore, the sensor 46 is provided and configured in the illustrated embodiment to optically capture an elevation difference between the elevation of the cargo space floor and the elevation of the driving plane of the pedestal 7 and to conduct the corresponding information to the data processing device. The data processing device is configured to process the information and to provide information to the driver of the transport device 2, e.g. by the signalling device 48 in order to give feedback to the driver regarding the anticipated elevation difference. The driver is subsequently enabled to perform an elevation adjustment of the transport device 2, e.g. by a pneumatic system of the transport device 2. The adaptation is advantageously performed so that no elevation difference exists anymore between the cargo space floor 39 and the pedestal 7.

Last not least the sensor 46 is provided and configured in the illustrated embodiment to optically detect the cargo space 3 or the walls 38, the cargo space floor 39 and/or a cargo space ceiling 40 of the transport device 2. Information captured in this manner is transmitted to the data processing device and processed therewith which enables detecting objects in general and in particular obstacles and/or contamination. The contamination can be provided in particular as contamination at the surfaces of the walls 38, the cargo space floor 39 and/or the cargo space ceiling 40. The data processing device is provided and configured to process the captured information and to control the cleaning robot 5 as a function of the information or as a function of the processing of the information.

The control includes in particular that at least one operating parameter of the cleaning robot 5 is set for at least one cleaning process of the respective cargo space 3. It is also conceivable to locally capture a contamination at a wall 38 of the transport device 2 by the sensor 46 and to control the cleaning robot 5 as a consequence of the processing of the information captured in this manner so that the cleaning robot temporarily reduces its driving speed in the longitudinal direction of the cargo space in an area of the detected contamination. This increases an application of the cleaning fluid to the location of the local contamination so that the contamination is removed in a controlled manner. It is also conceivable that a dispensing amount of the cleaning fluid that is dispensed locally in the area of the contamination by the cleaning robot 5 or a cleaning nozzle 33 is increased temporarily in order to load the contamination with an increased amount of cleaning fluid. This way, the cleaning robot 5 can be controlled as required for a respective cleaning process through the cooperation of the sensor 46 with the data processing unit of the control unit 6. An adjustment of at least one operating parameter of the cleaning robot 5 while performing the cleaning process and/or between different cleaning processes is also possible.

In the illustrated embodiment, a sensor may be formed by a Lidar. This sensor is used to capture dimensions of the cargo space 3. The information thus captured can be used to control the cleaning robot 5 to perform the cleaning automatically and/or to adjust at least one operating parameter for at least one cleaning process.

It is also possible to capture a contaminations condition of the cargo space 3 by a sensor that is formed by a camera or a lidar after completing the respective cleaning process. It is conceivable for example, that remaining solid objects or fluid puddles are detected in the cargo space 3 by the lidar sensor. In case no contamination is detected, the cleaning is deemed sufficient and terminated. An automatically generated cleaning certificate can be the result of the post-inspection of the cargo space 3 wherein the cleaning certificate not only documents that a prescribed cleaning was performed but also documents that an intended cleaning result has been achieved. Thus, it is conceivable that requirements for a cleaning success relating to an identified transport device are stored. Checking these requirements can be performed by sensor detection through at least one sensor, wherein the generated cleaning certificate documents the cleaning success when these requirements are met.

In case a propulsion of the cleaning robot 5 is impaired so that the cleaning robot 5 cannot exit the cargo space of the respective transporter under its own power, it is required to still remove the cleaning robot 5 from the cargo space 3 so that the transport device 2 is clean and can leave the cleaning station 1. This failure can be caused by a chassis 25 of the cleaning robot 5 being damaged or the power supply having failed or similar. In order to reliably remove the cleaning robot 5 from the cargo space 13, the cleaning station 1 includes a winch 52 in the illustrated embodiment wherein the winch 52 is arranged at a rear side wall 16 of the garage 8. The winch 52 includes a storage roller where a pull cable is would up. This pull cable can be connected with the cleaning robot 5 in a force transferring manner so that the pull cable is wound onto the storage roller by a rotation drive of the storage roller so that the cleaning robot 5 is extracted backward from the cargo space 3 against the main direction 32 of the cleaning robot 5. The cable winch 52 can be operated manually by a crank or by an electric drive. The cable winch 52 can be supplied with electrical energy from a battery in order to remain functional when an external power supply fails.

Additionally, the cleaning station 1 includes a cleaning device 53 in the illustrated embodiment, wherein the cleaning device is arranged at a bottom side of the roof 15 of the garage 8. The cleaning device 53 is configured to load the cleaning robot 5 with the cleaning fluid and thus clean the cleaning robot 5 when it is in its parking position in which the cleaning robot 5 is parked in the interior 17 of the garage 8. Thus, the cleaning device 53 can include in particular at least one cleaning nozzle that is configured to spray the cleaning fluid from above onto the cleaning robot 5. After the application of the cleaning fluid has been completed, a flushing with fresh water can be performed by the cleaning device 53. Advantageously, the space divider element 18 is closed when the cleaning of the cleaning robot 5 is performed within the garage 8.

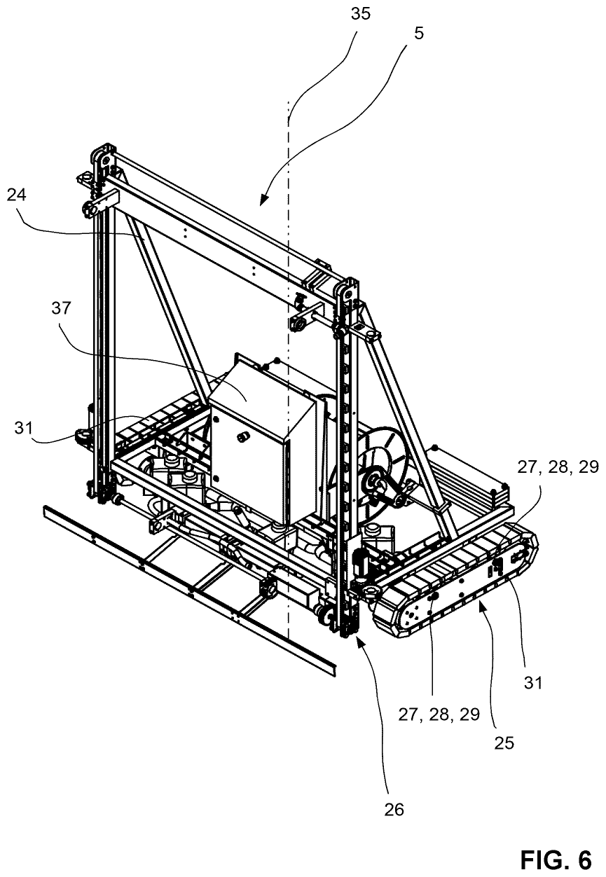

As recited supra, the cleaning of the respective cargo space 3 is performed by the cleaning robot 5 automatically or self-acting. This is evident in particular from FIGS. 6-8. The cleaning robot 5 includes a frame 24 which forms a support frame of the cleaning robot 5. Additionally, the cleaning robot 5 includes a chassis 25 which includes two drive tracks 31 in the illustrated embodiment, wherein the two drive tracks are arranged adjacent and parallel to one another. The drive tracks 31 in turn respectively include a running band or a running chain that is internally closed and drivable to revolve so that the cleaning robot 5 is movable relative to a ground using the drive tracks 31. Thus, the drive tracks 31 are arranged at a bottom side of the frame 24 that is oriented towards the cargo space floor 38 and drivable independently so that the cleaning robot 5 can be moved and controlled like a tank. In particular, a main direction 32 in which the cleaning robot 5 moves forward when synchronously driving the drive tracks 31 can be adjusted by asynchronously driving the drive tracks 31 so that the cleaning robot 5 rotates about its vertical axis 35.

The cleaning robot 5 additionally includes a cleaning unit 26 that is configured to dispense the cleaning fluid onto the walls 38, the cargo space floor 39, the cargo space ceiling 40, and the doors 55 of the transport device 2. Thus, the cleaning unit 26 includes a plurality of cleaning nozzles 33 that are arranged and distributed at the frame 24. The cleaning nozzles 33 are arranged at a front end of the cleaning robot 5 and respectively oriented to the sides or upward and downward in order to apply the cleaning fluid to the associated surfaces of the cargo space 3. In order to adjust the orientation of the cleaning nozzles 33 during a cleaning process, a plurality of the cleaning nozzles 33 is arranged at elongated nozzle rails 36 in the illustrated embodiment wherein the nozzle rails 36 are respectively pivotably supported about a longitudinal axis 34. In the illustrated embodiment, each direction is associated with a nozzle rail 36. This way, it is possible to operate the cleaning nozzles 33 in a first orientation relative to the walls 38, the cargo space floor 39, and the cargo space ceiling 40 when the cleaning robot 5 moves forward in the main direction 32. After reaching a face wall 51 of the transport device 2, the drive direction of the drive tracks 31 is reversed so that the cleaning robot 5 moves backward opposite to the main direction 32 back towards the pedestal 7. Before the reverse movement starts, the nozzle rails 36 are pivoted about their respective longitudinal axis 34 in order to remove dislodged contaminations from the cargo space 3 so that the cleaning nozzles 33 are oriented backward. This way, continued operation of the cleaning nozzles 33, this means spraying the cleaning fluid, flushes the contaminations in the direction of the pedestal 7 and out of the cargo space 3.

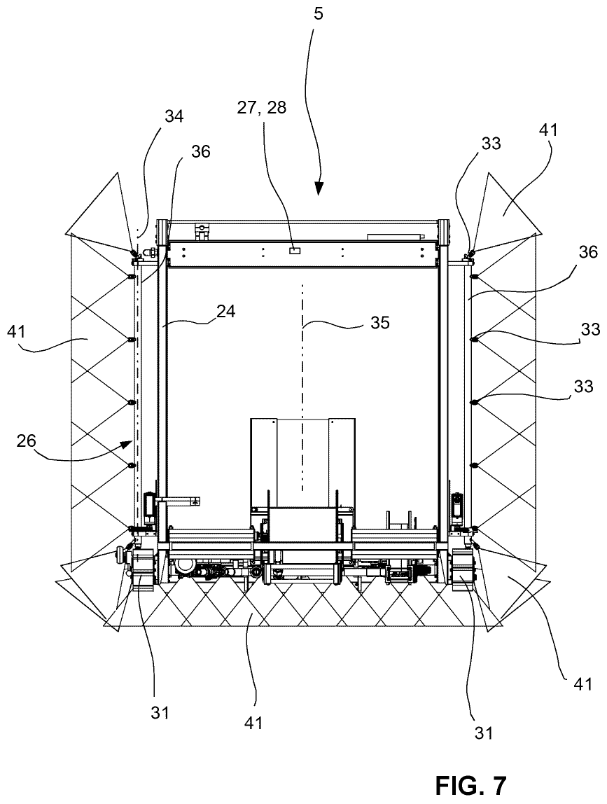

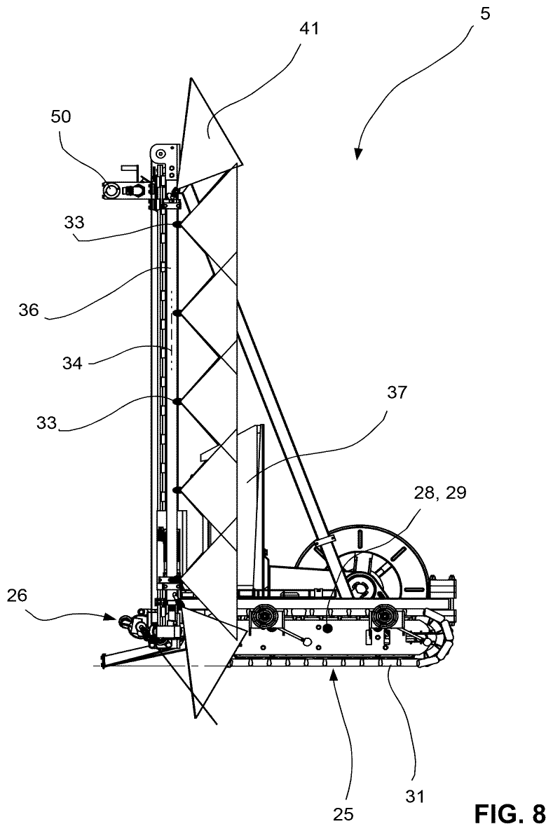

Dispensing the cleaning fluid through the cleaning nozzles 33 in spray cones 41 is shown in FIGS. 7 and 8. Adjusting the cleaning nozzles 36 is shown in the illustrated embodiment motor driven, wherein an electric drive is associated with each nozzle rail 36. The adjustability of the nozzle rails 36 and thus of the dispensing direction of the cleaning nozzles 33 is advantageous for targeted removal of local contaminations or dirt spots. Advantageously, these dirt spots can be sprayed with the cleaning fluid from different directions so that the dirt spots are scraped from the respective surface like using a high-pressure cleaner. Adjusting the dispensing direction of the cleaning fluid helps to achieve a particularly high cleaning performance.

Additionally, the cleaning unit 26 includes a plurality of valves configured to adjust the supply of the cleaning fluid to the individual nozzle rails. The valves can be used for throttling a flow-through amount of the cleaning fluid and also for cutting off plural nozzle rails completely. This way, it is possible to apply the cleaning fluid in a controlled manner to particular locations of the cargo space 3, e.g. to a strong contamination on a surface of a wall 38 of the transport device 2 which is not present in the same severity at the other walls 38.

Furthermore, it is particularly advantageous when the upper, transversally-extending nozzle rail 50 that is shown in FIG. 8 is moved downward along the frame 24 after reaching the face wall 51 of the transport device 2 and reversing the driving direction of the cleaning robot 5. This way, it is possible to apply the cleaning fluid to the face wall 51 through the cleaning nozzles 33 that are arranged at the nozzle rail 50 so that the face wall 51 is cleaned, as well. Accordingly, the cleaning robot 5 is configured so that the nozzle rail 50 is vertically moveable along the frame 24, e.g., by a threaded rod that is drivable to rotate. Before the cleaning robot 5 starts driving backwards, the nozzle rail 36 is moved up again so that it can clean the cargo space ceiling 40 during the backward movement. In order to change the orientation of the cleaning nozzles 33 that are arranged at the transversally-extending nozzle rail 50, the nozzle rail 50 cooperates with the electrical drive as described supra that pivots the nozzle rail 50 about its longitudinal axis 34. Thus, the cleaning nozzles 33 can be oriented towards the face wall 51 at least during the downward movement of the nozzle rail 50.

The cleaning robot 5 in the illustrated embodiment furthermore includes an electrical cabinet 37 which may include, in particular, a control unit 6. This is particularly advantageous in an embodiment where the control unit 6 that is arranged in the illustrated embodiment at the support frame 4 or at the garage 8 is locally arranged at the cleaning robot 5. Additionally, the electrical cabinet 37 can include additional switching devices for locally controlling the cleaning robot 5.

The cleaning robot 5 additionally includes a sensor device 27 including a plurality of sensors 28. The plurality of the sensors 28 is formed, in particular, by distance sensors 29, wherein two respective distance sensors 29 are arranged at the drive tracks 31 in the illustrated embodiment. This is evident, in particular, from FIG. 6. The distance sensors 29 can also be arranged laterally at the frame 24. The distance sensors 29 are used to detect a lateral distance of the cleaning robot 5 from the lateral walls 38 of the transport device 2, this means from the left side and also from the right side of the cleaning robot 5. The distance sensors 29 are thus formed by ultrasound sensors. Determining the distances of the cleaning robot 5 from both sides with reference to the side walls 38 of the transport device 2 facilitates determining the orientation of the cleaning robot 5 or the main direction 32 of the cleaning robot 5 with reference to a longitudinal axis of the cargo space 3. Thus, information captured by the distance sensors 29 is conducted to the data processing device and processed by the data processing device. It has to be prevented during a cleaning process of the cargo space 3 that the cleaning robot 5 contacts the walls 38 of the transport device 2 while driving, in particular a collision has to be prevented. Therefore, the orientation of the main direction 32 relative to the longitudinal axis of the cargo space 3 is very important.

The information captured by the distance sensors 29 is used to determine the orientation of the cleaning robot 5 within the cargo space 3 and correct the orientation as needed. In order to perform this correction, a rotation of the cleaning robot 5 about its vertical axis is required. Also in order to perform this rotation, information captured by the distance sensors 29 as recited supra is processed by the data processing device and the chassis 25 is controlled by the data processing device, in this case directly by the control unit 6, so that the drive tracks 31 of the chassis 25 of the cleaning robot 5 are operated asynchronously. It is also conceivable that only one of the drive tracks 31 is driven while the other drive track 31 is at a standstill. It is also possible that the drive tracks 31 are temporarily driven in opposite directions or with different speeds in the same direction. This concept and other concepts cause the intended rotation of the cleaning robot 5 about the vertical axis 35 and thus an adjustment of the main direction 32 in which the cleaning robot 5 travels when the drive tracks 31 are driven synchronously. This way, the cleaning robot 5 can be oriented in a particularly simple manner within the cargo space 3 so that the cleaning robot travels parallel to the longitudinal axis of the cargo space 3 during the cleaning process. Distances of the cleaning robot 5 from the lateral walls 38 can be checked continuously wherein a correction of the main direction 32 can be performed repeatedly as described supra. Thus, the orientation of the cleaning robot 5 can be performed within the cargo space 3 without having to establish physical contact to the lateral walls 38. Additionally, it is possible in a particularly simple manner to position the cleaning robot 5 at least essentially centrally between the lateral walls 38 of the transport device 2, so that the lateral distances of the cleaning robot 5 from the walls 38 are kept at least essentially equal.

Furthermore, the sensor device 27 includes additional sensors 28 that are formed by distance sensors 29. In particular, a distance sensor 29 is arranged at a front side of the cleaning robot 5 and oriented in the main direction 32 so that a distance of the cleaning robot 5 from an obstacle arranged in the main direction of the cleaning robot 5 is detectable. This way, the cleaning robot 5 can be positioned in a particularly simple manner relative to the front face wall 51 of the transport device 2, so that the cleaning robot 5 can be stopped in a timely manner before colliding with the front face wall 51. Additionally, the sensor device 27 includes a distance sensor 29 oriented in a rear direction of the cleaning robot 5. This sensor can be particularly advantageous for moving into the parking position within the garage 8, wherein a distance of the cleaning robot 5 from the rear wall 16 of the garage 8 can be detected.

The sensor device 27 includes an additional sensor 28 in this embodiment that is formed by a combined temperature and humidity sensor. This sensor 28 facilitates capturing information regarding temperature and humidity in the cargo space 3 during a cleaning process. This information is processed, in particular, by the data processing device of the control unit 6, so that an operating parameter of the cleaning robot 5 can be adjusted as a function of the detected information. The captured information can also be used to monitor the cleaning and to assure and document the quality of the cleaning. Respective data can be documented as part of the cleaning certificate recited supra.

Additional sensors 28 can be formed, e.g. by a pressure sensor or a flow-through sensor that are configured to capture information relating to the cleaning fluid. Thus, it can be determined which flow-through amount of cleaning fluid is dispensed at a nozzle rail 36 or what pressure is applied to dispense the cleaning fluid through the cleaning nozzles 33. This information can be used to adjust the control of the cleaning robot 5 and to influence the operating parameters accordingly. Disturbances in the fluid supply 9 are also detectable wherein a sudden drop of the pressure of the flow-through amount of the cleaning fluid indicates a disturbance.

After dispensing the cleaning fluid successfully through the cleaning unit 26, it is conceivable that the cargo space 3 is dried in order to complete the cleaning. Thus, it is conceivable to apply an air flow in particular to the cargo space floor 39 or to the walls 38 and the cargo space ceiling 40 using the cleaning nozzles 33 or separate air outlets, which dries out humidity caused by the dispensing of the cleaning fluid.

### REFERENCE NUMERALS AND DESIGNATIONS

1 Cleaning station
2 Transport device
3 Cargo space
4 Support frame
5 Cleaning robot
6 Control unit
7 Pedestal
8 Garage
9 Fluid supply
10 Capture container
11 Stand element
12 Contact plane
13 Ground
14 Floor
15 Ceiling
16 Side wall
17 Interior space
18 Space divider element
19 Fluid tank
   20 Fluid tank
   21 Fluid tank
   22 Pump
   23 fluid conduit
   24 Frame
   25 Chassis
   26 Cleaning unit
   27 Sensor device
   28 Sensor
   29 Distance sensor
   30 Edge
   31 Drive track
   32 Main direction
   33 Cleaning nozzle
   34 Longitudinal axis of nozzle rail
   35 Vertical axis
   36 Nozzle rail
   37 Electrical cabinet
   36 Wall
   39 Cargo space floor
   40 Cargo space ceiling
   41 Spray cone
   42 Outer portion of pedestal
   43 Intermediary space
   44 Input device
   45 Display device
   46 Sensor
   47 Storage box
   48 Signaling device
   49 Capture device
   50 Nozzle rail
   51 Face wall
   52 Cable winch
   53 Cleaning device
   54 Door support
   55 Door
   56 Processing device

1. A cleaning station for cleaning a cargo space of a transport device, the cleaning station comprising:
an inherently stable support frame configured to support a pedestal above a ground;
a cleaning robot;
a garage, configured to receive the cleaning robot;
a fluid supply, configured to supply the cleaning robot with a cleaning fluid; and
a control unit,
wherein the support frame includes at least one stand element configured to support the support frame on a support plane on the ground,
wherein the garage includes an interior space enclosed by a floor, a roof (15), and side walls,
wherein at least one of the side walls of the garage is at least partially configured as an openable space divider element, wherein the cleaning robot is alternatively movable out of the garage or into the garage in an open position of the space divider element, and wherein the cleaning robot is storable in the garage, protected against unauthorized access when the space divider element is in the closed position,
wherein the fluid supply includes a fluid tank, a pump and a fluid conduit operatively connected with the fluid tank and the cleaning robot indirectly or directly, so that cleaning fluid stored in the fluid tank is pumpable indirectly or directly by the pump through the fluid conduit to the cleaning robot,
wherein the control unit is configured to control operations of the cleaning station according to at least one cleaning program so that the cleaning robot automatically performs a cleaning process to clean the cargo space.

2. The cleaning station, according to claim 1, wherein at least a portion of the pedestal forms the floor of the garage, wherein the pedestal includes an outer portion arranged outside the garage, and wherein the cleaning robot is moveable onto the outer portion when driving out of the garage.

3. The cleaning station according to claim 1, further comprising: at least one sensor connected with a data processing device so that data is transmittable to the data processing device, wherein information captured by the at least one sensor is transmittable to the data processing device by a transceiver.

4. The cleaning station according to claim 3, characterized in that the at least one sensor is formed by an optical sensor or a camera.

5. The cleaning station according to claim 3, wherein the data processing device is configured to process captured information and adjust at least one operating parameter of the cleaning robot indirectly or directly as a function of the processed information using the control unit.

6. The cleaning station according to claim 3,
wherein the sensor is configured to detect at least one identification feature of the transport device whose cargo space is to be cleaned, and
wherein information captured by the sensor is transmittable to the data processing device that is configured to process the information and thereby identify the transport device.

7. The cleaning station according to claim 3, wherein the at least one sensor is configured to detect an elevation level of a cargo space floor of the cargo space that is to be cleaned, wherein signals regarding an elevation difference between the cargo space floor and the pedestal are transmittable to a driver of the transport device through a signaling arrangement.

8. The cleaning station according to claim 1, further comprising: a capture device arranged at an elevation level below a driving plane of the pedestal, wherein the cleaning robot is configured to drive on the driving plane, wherein the cleaning fluid dispensed by the cleaning robot is retrievable by the capture device.

9. The cleaning station according to claim 8, further comprising: a processing device configured to process the cleaning fluid captured by the capture device using a filter, wherein the processed cleaning fluid is configured to be at least partially used in at least one cleaning process after the processing.

10. The cleaning station according to claim 1, characterized in that the fluid supply includes two additional fluid tanks, wherein a first additional fluid tank is formed by a water tank configured to store fresh water and a second additional fluid tank is formed by a cleaning agent tank configured to store a cleaning agent.

11. The cleaning station according to claim 1, further comprising at least one door stop configured to stop at least one door of the transport device in a defined open position, wherein the at least one door is stoppable in the defined open position in an opening angle range between 80 degrees and 110 degrees or between 85 degrees and 100 degrees.

12. The cleaning station according to claim 11, wherein the door stop is laterally arranged at the support frame, so that the at least one door of the transport device is laterally fixable at the pedestal.

13. The cleaning station according to claim 1, further comprising: a cable winch including a pull cable windable or wound onto a storage roller, wherein an end of the pull cable oriented away from the storage roller is connectable or connected with the cleaning robot, so that the cleaning robot is pullable towards the storage roller by operating the cable winch.

14. The cleaning station according to claim 1, further comprising:
a cleaning device arranged in the interior space of the garage,
wherein the cleaning robot is cleanable in the interior space at least when the cleaning robot is in a parking position,
wherein the cleaning device includes at least one cleaning nozzle configured to spray the cleaning robot with the cleaning fluid.

15. The cleaning station according to claim 14, wherein the cleaning device is arranged at the roof of the garage, so that the cleaning robot arranged in the parking position is sprayable with the cleaning fluid from above.
